(19) United States
(12) Patent Application Publication
(10) Pub. No.: US 2013/0189914 A1
(43) Pub. Date: Jul. 25, 2013

(54) SYSTEMS AND METHODS FOR PRODUCING MUSIC AND/OR OTHER MEDIA ARRANGEMENTS WITH COIN COUNTING MACHINES

(71) Applicants: Douglas A. Martin, Woodinville, WA (US); Daniel D. Everhart, Edmonds, WA (US); Lawrence D. Azzano, Seattle, WA (US); Alexander S. Templeton, Seattle, WA (US); Michael A. Stoy, Bothell, WA (US)

(72) Inventors: Douglas A. Martin, Woodinville, WA (US); Daniel D. Everhart, Edmonds, WA (US); Lawrence D. Azzano, Seattle, WA (US); Alexander S. Templeton, Seattle, WA (US); Michael A. Stoy, Bothell, WA (US)

(21) Appl. No.: 13/356,309

(22) Filed: Jan. 23, 2012

(51) Int. Cl. G07D 9/00

(52) U.S. Cl. 453/58

(57) ABSTRACT

Systems and methods for generating unique audio and/or video arrangements from coins counted by a coin counting machine are described herein. In one embodiment, the coin counting machine can receive coins and detect one or more properties of each coin. The properties of each coin may be associated with a musical note, graphic, and/or other media component. The media components can be combined to create a media arrangement that can be presented via a speaker, video display, or other media output on the coin counting machine.

### TECHNICAL FIELD

The following disclosure relates generally to systems, apparatuses and methods for generating audio and/or video arrangements from a sequence of coins as the coins are deposited, discriminated, counted, and/or sorted by a coin counting machine.

### BACKGROUND

Various vending machines are configured to dispense selected products to users in exchange for exact amounts of money. Such machines include, for example, food dispensing machines, stamp dispensing machines, ticket dispensing machines, and the like. Other machines are configured to count arbitrary numbers and denominations of coins received from users. One such coin-counting machine is disclosed in U.S. Pat. No. 5,620,079 to Molbak (“the '079 Patent to Molbak”), which is incorporated herein in its entirety by reference. In one embodiment, the Molbak coin-counting machine can dispense a redeemable voucher to a user for an amount related to the value of coins received from the user. The voucher can be redeemed for cash or merchandise at, for example, a point-of-sale (POS) location in the retail outlet where the machine is located.

Coin machine operators are continually seeking ways to increase the number of consumers that utilize their machines, the number of coins the consumers deposit, and the frequency of future transactions in which the consumers utilize the machines. Accordingly, it would be advantageous to use information from a particular coin transaction to incentivize consumers to increase their usage of the coin counting machine and the number of coins counted per transaction.

### BRIEF DESCRIPTION OF THE DRAWINGS

FIG. 1 is an isometric view of a coin counting kiosk configured in accordance with an embodiment of the present disclosure.

FIG. 2 is an isometric view of a coin counting unit configured in accordance with an embodiment of the present disclosure.

FIG. 3 is a flow diagram illustrating a routine for producing media arrangements from count-counting transactions in accordance with an embodiment of the present disclosure.

FIG. 4 is a flow diagram illustrating a routine for producing media arrangements from count-counting transactions in accordance with another embodiment of the present disclosure.

FIG. 5 is a flow diagram of a routine for outputting one or more media events after the coin counting machine 101 has rejected an object in accordance with one or more embodiments of the disclosure.

FIG. 6 is a flow diagram of a routine for distributing a file comprising a media arrangement created using a coin counting media creation system in accordance with certain embodiments of the disclosure.

FIG. 7 is a diagram showing an exemplary mapping of a coin sequence to musical notes in accordance with an embodiment of the present disclosure.

FIG. 8 is an illustration showing various file distribution methods in accordance with one or more embodiments of the present disclosure.

### DETAILED DESCRIPTION

The following disclosure describes various embodiments of apparatuses, systems, and methods for generating and presenting an audio and/or video arrangement (e.g. a musical arrangement) from a sequence of coins as the coins are deposited, discriminated, counted, and/or sorted by a coin counting machine.

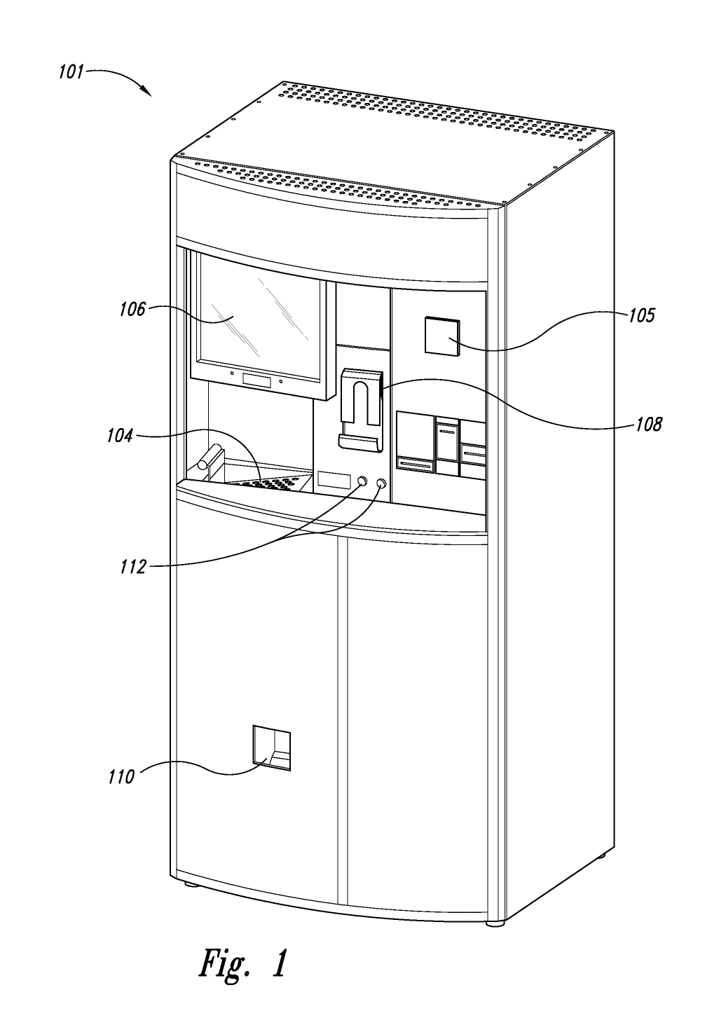

Certain details are set forth in the following description and in FIGS. 1-8 to provide a thorough understanding of various embodiments of the disclosure. Those of ordinary skill in the relevant art will appreciate, however, that the technology disclosed herein can have additional embodiments that may be practiced without several of the details described below and/or with additional features not described below. In addition, some well-known structures and systems often associated with coin counting apparatuses and methods have not been shown or described in detail below to avoid unnecessarily obscuring the description of the various embodiments of the disclosure.

The dimensions, angles, features, and other specifications shown in the figures are merely illustrative of particular embodiments of the disclosure. Accordingly, other embodiments can have other dimensions, angles, features, and other specifications without departing from the scope of the present disclosure.

FIG. 1 depicts a coin counting machine or kiosk 101 configured in accordance with an embodiment of the disclosure. In this embodiment, a consumer or other user places coins in a coin input region 104 (e.g. a tray) to begin the counting process. He or she then pushes a “start” button 105 and lifts the tray to introduce the coins into the kiosk 101. A video screen 106 may display user directions, transaction information, store bargains, and/or advertisements. Once the coins are admitted into the kiosk 101, the coin counting process begins. During the coin counting process, coins that do not meet predetermined physical criteria are rejected and returned to the user via an outlet chute 110.

At the conclusion of the counting process, the user may be asked to either accept the stated coin value and continue the transaction, or cancel the transaction. This selection may be made, for example, by pushing one of two buttons 112. If the user continues the transaction, he or she may be issued a redeemable voucher through a voucher slot 108. In some embodiments, the kiosk 101 can dispense other types of output in return for the coins, such as gift cards, e-certificates, etc. As those of ordinary skill in the art will appreciate, the kiosk 101 is but one example of a coin counting machine that can include the various audio and/or video features disclosed herein. Accordingly, the present disclosure is not limited to any particular configuration of coin counting machine or other type of monetary processing machines. Further details describing the structures and functions of various aspects and features of the kiosk 101 can be found in, for example, U.S. Patent Nos. 5,620,079; 5,746,299; 6,047,808; 5,988,348; 6,196,371; 6,116,402; 6,349,972; 5,909,793 and 8,024,272, all of which are incorporated herein in their entireties by reference.

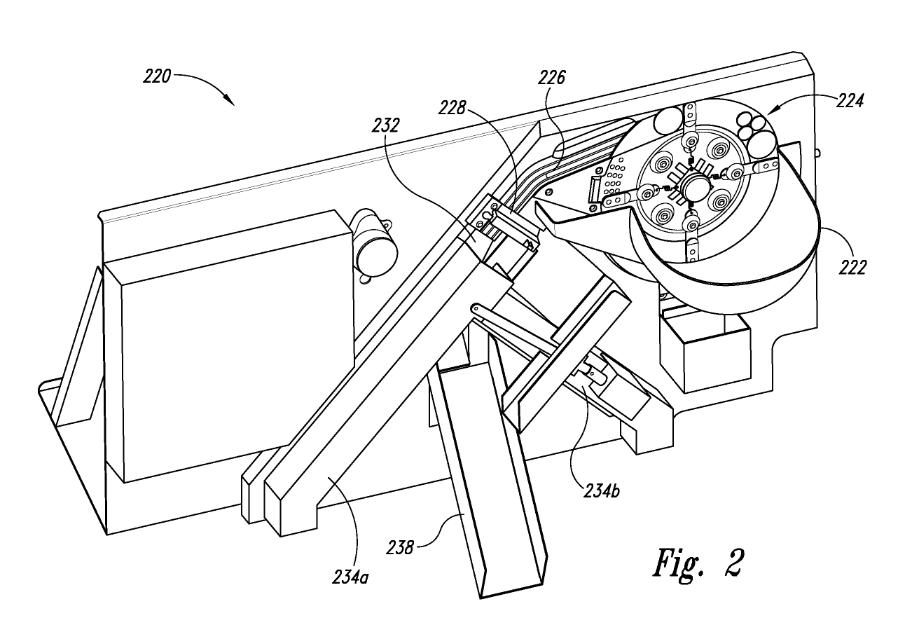

FIG. 2 is an isometric view of a coin counting system or unit 220 having a coin pickup assembly 224, a rail 226, a sensor 228, and a reject chute 238 configured in accordance with an embodiment of the present disclosure. After a user deposits coins into, for example, the coin input region 104 of FIG. 1, the coins may travel into a cleaning apparatus (e.g. a trommel, not shown) before entering a hopper 222. The coin pickup assembly 224 carries the individual coins from the hopper 222 and places them on the rail 226. The coins then roll down the rail 226 and past the sensor 228. If, based on sensor data, it is determined that an individual coin can and should be accepted, a controllable deflector door 232 is activated to divert the coin into one of two coin tubes 234 (identified individually as a first coin tube 234a and a second coin tube 234b) for delivery to one or more coin bins (not shown). If the sensor indicates that the coin can not and should not be accepted, the door 232 is not activated and the coin (or other object) continues down the reject chute 238 for delivery to a customer-accessible reject or return box (not shown).

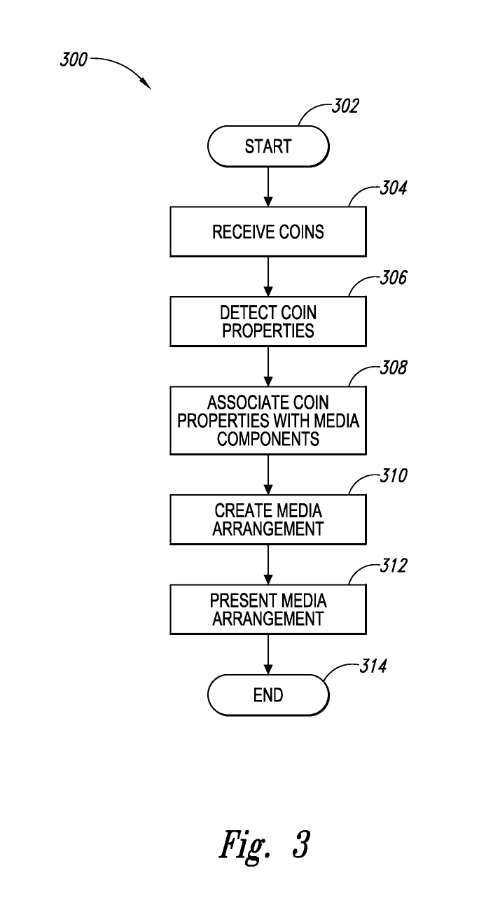

FIG. 3 is a flow diagram of a routine 300 for creating music and/or other media arrangements with a coin counting machine, such as the coin counting kiosk 101 and/or the coin counting unit 220 (FIGS. 1 and 2) in accordance with one or more embodiments of the present disclosure. In block 302, the routine is ready to accept coins from a user. In one aspect of this embodiment, the user may elect to perform multiple transactions with multiple types of input (e.g. coins, tokens, currency, and/or cards) and receive multiple types of output (e.g. vouchers, currency, e-certificates, cards, etc.). In block 304, the routine receives a deposit of coins. In block 306, the routine analyzes the coins by detecting one or more properties of each coin (e.g. denomination). The routine can then store information associated with the individual coin-sensing events (e.g. the time between individual coin-sensing events, denomination, etc.). In block 308, the information stored for each coin is associated with an individual media component. The media component can be, for example, a particular sound or musical note, a visual pattern, a still image, or a combination thereof.

For example, the denomination of a particular coin can be associated with a musical note and/or a still image. As described in further detail below, coin-sensing event information (e.g. coin timing or spacing) can be used to map one or more coin properties to musical notes. In block 310, certain coin-sensing events can trigger the system to create a media arrangement that includes a series of media components (e.g. musical notes) assembled together. For example, the routine may discriminate a sequence of coins that totals or exceeds a predetermined accumulative value. When the routine detects that the predetermined accumulative value has been reached, the media components associated with the coins that contributed to the value can be combined to produce a media arrangement (e.g. a song, a video, and/or a slideshow of still images). Other trigger events may include a predetermined sequence of coins and/or a predetermined count of coins (e.g. a media arrangement may be presented after the system reads a one-hundredth coin). In some embodiments, the media components can be arranged in the same order as the associated coins were read by the machine, while in other embodiments the media components can be combined in other orders (e.g. sorted by associated coin denomination, size, etc.).

In block 312, the routine presents the resulting media arrangement. The presentation of the media arrangement can comprise an audio output (e.g. via a speaker or headphones) and/or a video output (e.g. via a computer screen, television, and/or mobile device screen). In some embodiments, the media arrangement can be saved as a media file, which the routine can distribute to the user through various means, such as, for example, uploading the media file to an Internet page and/or a mobile device, or sending the media file to the user via an email address or other electronic address. In block 314, after all of the coins in the transaction have been counted and/or analyzed, the routine can display the total amount of coins counted and dispense, for example, a corresponding redeemable voucher to the user, thus ending the transaction.

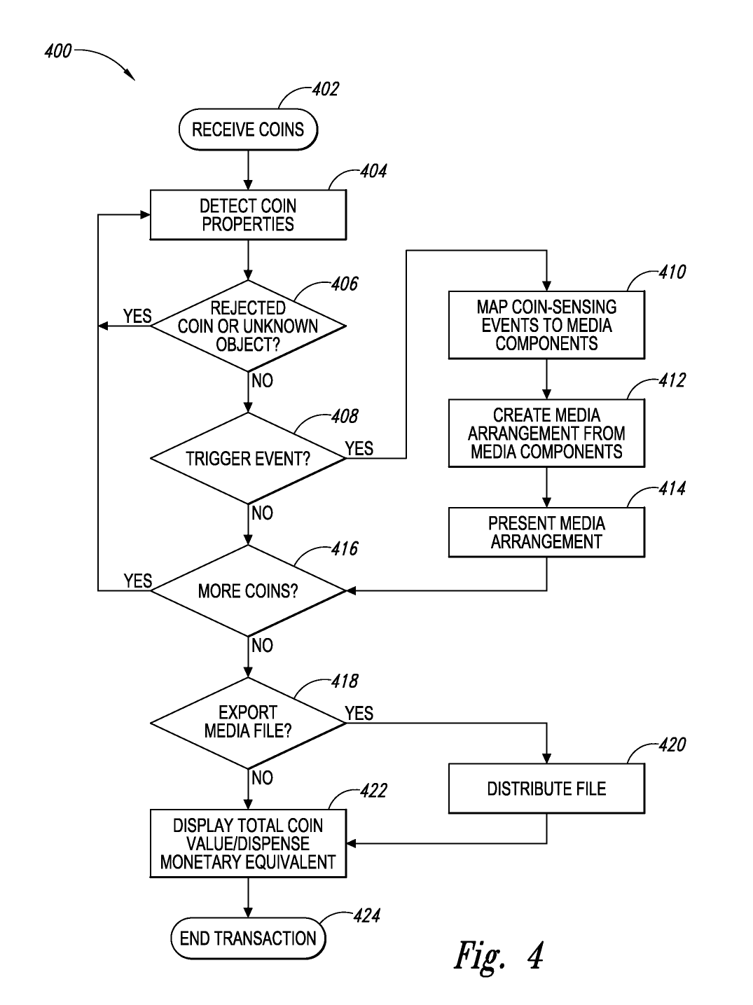

FIG. 4 is a flow diagram of a routine 400 for creating a media arrangement with a coin counting machine, such as the coin counting kiosk 101, in accordance with another embodiment of the present disclosure. In block 402, the routine receives a deposit of coins. In block 404, a first coin is discriminated by the routine to determine one or more properties of the first coin, such as, for example, the coin denomination, size, etc. In decision block 406, if the first coin does not meet predetermined physical coin criteria, the routine rejects the first coin and returns to block 404 to detect the properties of a second coin. As discussed in further detail below with regard to FIG. 5, in some embodiments the rejection of coins may be associated with certain media events. The routine stores the data acquired during the coin-sensing events in block 404. The data associated with successive coins is stored as a sequence of information.

In decision block 408, if the routine determines that the first coin is indeed valid, then the routine determines if a trigger event has occurred. The reading of a particular coin and/or a coin sequence (which can include, for example, the detection of a particular coin denomination, accumulative value of the sequence, a certain number count of coins in the sequence, a particular string of coins in the sequence, and/or another predetermined level or event) may cause a trigger event. In block 410, when a trigger event occurs, the system maps data from all or some of the coin-sensing events to corresponding media components. As previously stated, the media components can include, for example, musical notes, visual patterns, still images, and/or a combination thereof. In block 412, the media components are combined to create, for example, a music and/or other media arrangement that can be presented or output in block 414, allowing, for example, playback by one or more users.

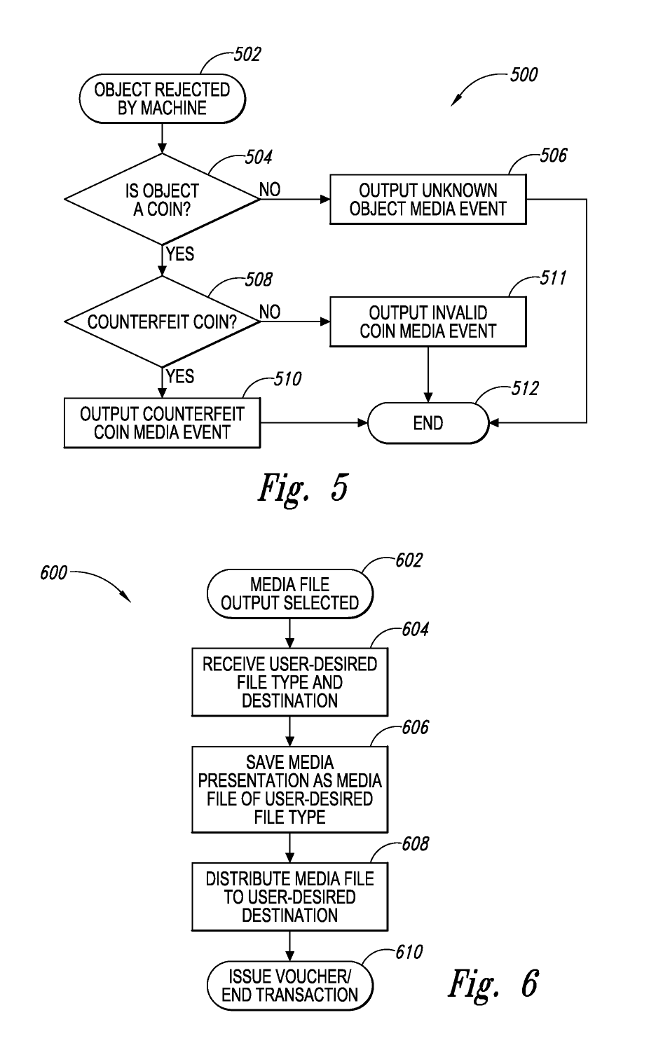

In decision block 416, the routine determines whether there are more coins to process after block 408 or block 414. If there are additional coins to process, the routine 400 returns to block 404 and repeats. If there are no further coins to process, the user is asked in block 418 whether the media arrangement should be saved as a media file and exported. In block 420, as discussed in further detail below with regard to FIG. 6, if the file is to be exported, several file distribution options are presented and the file distributed according to one or more user-selected methods. In block 422, the routine displays the total value of the coins collected (or the total value less a fee) and dispenses, for example, a redeemable voucher or other output to the user. The output can include, for example, cash, a voucher, a coupon, an e-certificate, a prepaid card, etc. In block 424, the transaction ends.

One reason an operator may implement a coin counting media creation system into a coin exchange kiosk is to incentivize the user to deposit valid coins. Similarly, the system may also be configured to incentivize the user not to deposit invalid coins, counterfeit coins, and/or foreign objects. FIG. 5, for example, is a flow diagram of a routine 500 for outputting one or more media events after the coin counting machine 101 has rejected a counterfeit coin or other object in accordance with one or more embodiments of the disclosure. In block 502, the routine rejects an object that is not a valid coin because it did not meet predetermined physical criteria. In some embodiments, block 502 may follow decision block 406, described in reference to FIG. 4 above. In block 504, after the routine rejects the object, it determines whether the rejected object is a coin. For example, the routine can reject transit tokens, video game tokens, car wash tokens, foreign coins, etc. as being invalid. In block 506, if the routine cannot identify the coin and/or determines that the object is not a coin at all, an unknown object media event may be output. For example, a visual cue accompanied by a sound produced by the system can alert the user that an identified object has been detected. The visual cue may be, for example, a still image, a solid color, a pattern, a video, and/or a series of images and/or patterns. The sound may be, for example, a musical tone, a song, and/or a sound effect.

In block 508, if the rejected coin is indeed a coin, the routines determines whether the coin may be classified as counterfeit. In block 510, if the routine suspects the coin is counterfeit, a counterfeit coin media event can be output. In block 511, if the coin is not suspected of being counterfeit, an invalid coin media event may be output. In some embodiments, the media events associated with all rejections in blocks 506, 510 and 511 may be identical. In other embodiments, the media events may be configured to increase in severity from the invalid coin media event in block 511 to the counterfeit coin media event in block 510. For example, a coin exchange kiosk operator may consider an invalid coin detection to be considered to be relatively benign. Thus, the invalid coin media event in block 511 may comprise, for example, only an audio beep and/or a visual indicator. However, if the kiosk operator considers receiving one or more counterfeit coins to be more of a concern, the counterfeit coin media event in block 510 may comprise significantly more conspicuous audio (e.g. a loud siren, horn, klaxon, etc.) and/or visual events (e.g. flashing lights and/or images), particularly if the system detects multiple counterfeit coins in block 508. In block 512, after the system outputs the media event associated with the type of rejection, the operation ends and returns to the next coin-sensing event (e.g. block 404 of FIG. 4).

FIG. 6 is a flow diagram of a routine 600 for distributing a file comprising a media arrangement created with, for example, a coin counting kiosk configured in accordance with embodiments of the present disclosure. In block 602, a user has already indicated, for example, via a touchscreen on the kiosk, that he or she would like to save the media arrangement to a media file. In block 604, the routine presents the user with one or more file type options and one or more destination options for the file. For example, the user may have the option to upload and save the media arrangement as a ringtone file on a mobile device. The user may also have the option to upload and save the media arrangement as, for example, an MP3 file, WAV file, MIDI file, or any other suitable audio file format. The user may choose to have the media file distributed to any number of destinations. For example, the media file can be uploaded to a public or private website or emailed to a user-specified email address. The media file can also be sent to a mobile device via any number of distribution means (e.g. the Internet, cellular telephone data, and/or near field communication). The media file can also be transferred directly to a mobile device via physical engagement with the coin exchange kiosk. A mobile device equipped with, for example, a USB plug, may releasably connect to the kiosk for the purpose of transferring data. In some embodiments, the kiosk may be configured to transfer the media file to several devices simultaneously.

In block 639, the routine saves the media arrangement in one or more of the user-selected formats. In block 640, the routine distributes the media file to one or more of the user-selected destinations. In block 642, the routine issues a voucher or other output for the collected coins and ends the transaction.

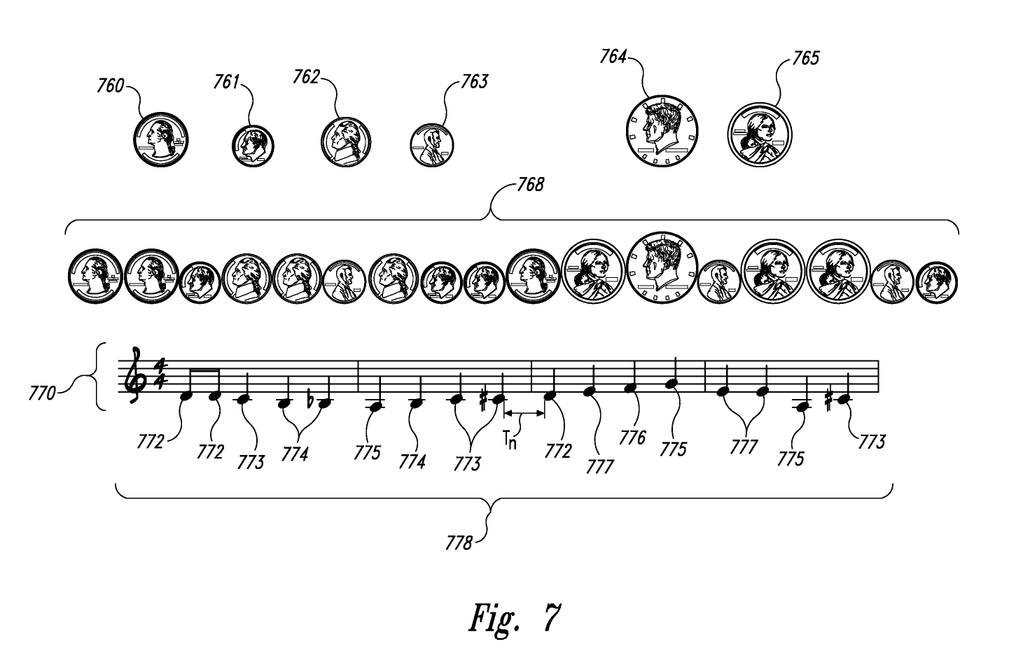

FIG. 7 is a diagram showing an exemplary mapping of a coin sequence 768 to a plurality of media components 772-777 in accordance with one or more embodiments of the coin exchange media creation system. FIG. 7 illustrates a plurality of different coins 760-765 as identified in the table below:

| Element Number | Coin Type |
|---|---|
| 760 | US quarter |
| 761 | US dime |
| 762 | US nickel |
| 763 | US penny |
| 764 | US half dollar |
| 765 | US dollar |

In the illustrated embodiment, the coins 760-765 have the coin types and denominations listed in the table above. In other embodiments, however, the coins 760-765 can be of any type or denomination. The sequence 768 corresponds to the coins 760-765 in the order they were discriminated by the system. The coin sensing data (e.g. coin denomination and/or time between coin sensing events) collected by the system for each of the coins 760-765 is associated with the media components 772-777, respectively, to create a media arrangement 778. In the illustrated embodiment, the media components 772-777 are musical notes arranged on a musical scale 770 having musical pitches associated with the denominations of the coins 760-765, respectively. A time Tₙ between any of the media components 772-777 can, in some embodiments, be determined by the time between coin-sensing events for an associated coin 760-765 in the sequence 768. When a trigger event occurs (e.g. reaching a preset total value), the system can present (e.g. by audibly playing the arrangement 778) and/or save the media arrangement 778.

In some embodiments, the media components 772-777 may optionally be musical notes that have been quantized. As those of ordinary skill in the art know, quantization can be performed by the system to cause musical notes that are not in sync with a given time signature (e.g. 4/4 as shown on musical scale 770) to shift in time so they occur on a beat, or some interval of a beat. Since the coin-sensing events discussed above may occur randomly without a consistent sequential spacing, the system may arrange musical notes without regard to a specific time signature. To some listeners, playback of musical notes arranged in this way may sound dissident and non-musical. To prevent this, the system can use quantization to shift the arrangement of musical components 772-777 on the musical scale 770 to the closest beat, or segment of the beat. In doing so, the musical components 772-777 may better conform to the time signature of the musical scale 770 and sound more musical to a listener.

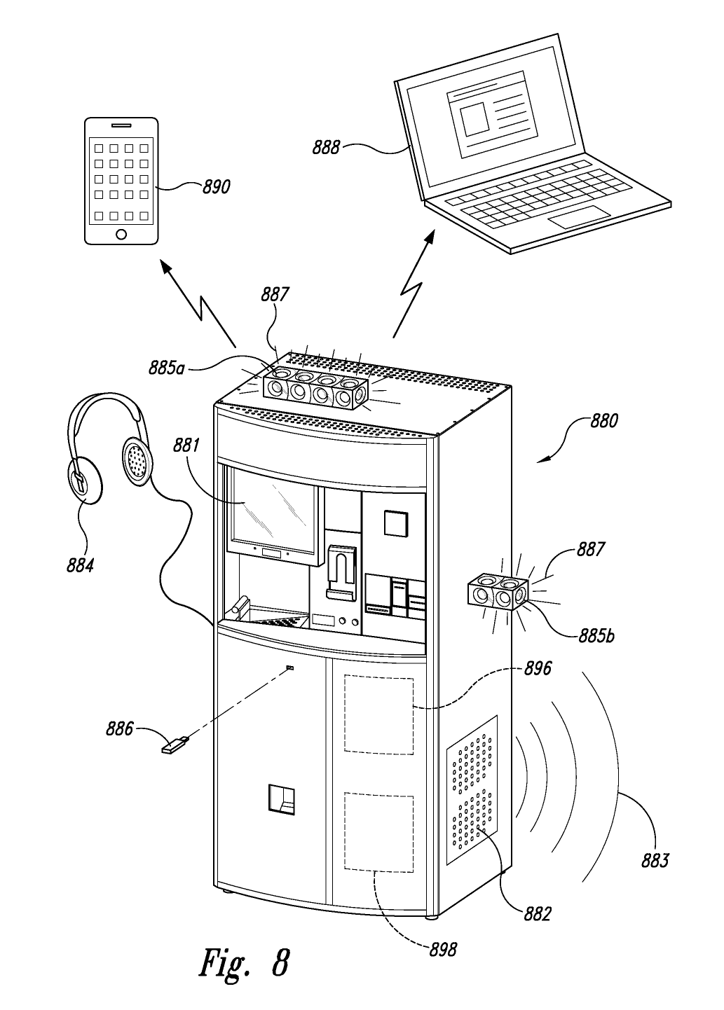

FIG. 8 is a schematic illustration depicting various systems for presenting and/or distributing a media arrangement from a coin counting system 880 in accordance with various embodiments of the disclosure. After a trigger event has occurred, one or more media arrangements can be output from the system 880 by a number of different systems and methods. For a media arrangement with audio information 883, for example, the arrangement can be output via a speaker 882 and/or a pair of headphones 884. The audio information 883 can be, for example, a single tone, a monophonic string of tones, a chord, a specific sound file, a song, and/or a sound effect. The sound effects may include, for example, animal sounds (e.g. frogs croaking, birds singing, dogs barking, etc.), video game sounds, sounds associated with casino machines (e.g. slot machines or roulette tables), and/or other sound effects (e.g. cars crashing, horns blowing, guns firing, etc.). In some embodiments, a user may be able to interact with the arrangement. The system can also provide a simulated, interactive musical instrument (not shown) on a display screen 881. For example, the system 880 may output a song via speaker 882 and present a simulated, interactive drum machine on the display screen 881. The user can play along with the song on the drum machine and his or her instrument playing can be incorporated into a media file to be output.

In some embodiments, the system 880 can also output media arrangements having video information via the display 881. The video information can include a series of patterns, colors, and or shapes, as well as a video file and/or one or more still images. The video information may be created using media components associated with coin sensing data. For example, the video information can include a series of still images associated with the coins read by the system in the order they are detected by the system.

In another example, the system 880 may utilize a media arrangement with audio information to create a corresponding video presentation. The corresponding video presentation may include, for example, a video generated in response to the audio information in the media arrangement. The generated video include, for example, a presentation of a color organ and/or visual elements animated so that the elements correspondingly move on the screen 881 with the audio information contained in the media arrangement. In some embodiments, the system 880 may also include one or more light emitters 885 (identified separately as a first light emitter 885a and a second light emitter 885b). The light emitters 885 may include, for example, light bulbs, light emitting diodes (LEDs), and/or laser projectors. The light emitters 885 can emit a light output 887, which can be directed, for example, toward a user, a floor, and/or a ceiling adjacent to the system 880. The light output 887 can be light and/or a laser output having one or more colors and may be configured to be intermittently displayed (e.g. to blink and/or flash). The intermittent display of the light output 887 can be varied or modulated in accordance with, for example, a media arrangement containing audio information.

The system 880 can also save the media arrangement for future listening and/or viewing. For example, the system 880 can store the arrangement as a media file in any number of suitable file formats. If the media file contains audio information, the media file can be saved as general sound file (e.g. MP3, WAV, WMA, MIDI, etc.), a ringtone file (e.g. 3GP, AAC, PDB, etc.), or as a musical score. If the media file contains video information, the media file can be saved as a video file (e.g. AVI, MPG, MOV, etc.).

The system 880 can export the media file via any number of suitable distribution methods, including, but not limited to, a multimedia messaging service (MMS) message; a text message containing a code (e.g. an alphanumeric sequence) and/or URL pointing to a website where the media file can be downloaded; a code (e.g. an alphanumeric sequence and/or a bar code) and/or a URL displayed on the screen 881 and/or on a voucher or other printed media; and/or via near-field communications (NFC), in which the mobile device 890 can be tapped against an NFC reader (not shown) on the kiosk 880 to initiate a transfer of the media file and/or a URL. The media file can also be distributed via a device interface (e.g. a USB port) configured to accept a storage device 886 (e.g. a USB thumb drive or a mobile device) capable of engaging the interface. The media file can also be distributed to any number of devices capable of audio and/or video playback, such as, for example, a personal computer 888 and/or a mobile device 890, via the Internet or other suitable distribution means (e.g. via wired and/or wireless transmission).

Those of ordinary skill in the art will recognize the system 880 described above with reference to FIG. 8 can comprise a memory 896 connected to a processor 898. The processor 898 can be configured to execute one or more instructions stored in the memory 896, presenting one or more of the media arrangements described in detail above to the user. In one embodiment, for example, the processor 898 can be connected to the display 881, the speaker 882, the headphones 884, and/or the light emitters 885. The processor 898 can execute the instructions in the memory 896 to, for example, output audio by the speaker 882 and/or the headphones 884. Similarly, the instructions in the memory 896, when executed by the processor 898, can also result in, for example, visual output via the display 881 and/or the light emitters 885.

One skilled in the relevant art will appreciate that the concepts of the disclosure can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the disclosure described herein can be implemented in or for any e-mail environment.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural or singular number, respectively. Additionally, the words “herein,” “above” and “below” and words of similar import, when used in this application, shall refer to this application as a whole and not to any particular portions of this application.

The description of embodiments of the disclosure is not intended to be exhaustive or to limit the invention to the precise form disclosed. While specific embodiments and examples are described herein for illustrative purposes, various equivalent modifications are possible within the scope of the disclosure, as those skilled in the relevant art will recognize. For example, while functions are presented in a given order, alternative embodiments may perform functions in a different order, or functions may be performed substantially concurrently. The teachings of the disclosure provided herein can be applied to other systems, not only the system described herein. The various embodiments described herein can be combined to provide further embodiments.

All of the references cited herein are incorporated by reference. Aspects of the disclosure can be modified, if necessary, to employ the systems, functions and concepts of the above references and application to provide yet further embodiments of the disclosure. These and other changes can be made to the invention in light of the

### DETAILED DESCRIPTION

Aspects of the invention described in detail above can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention, such as the routines described above with reference to FIGS. 3-6, may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

One skilled in the relevant art will appreciate that the concepts of the invention can be used in various environments other than location based or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can be implemented in or for any e-mail environment.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the invention. Accordingly, the invention is not limited, except as by the appended claims.

1. A method of operating a coin counting machine, the method comprising:
receiving a plurality of coins from a user;
detecting a property for each individual coin;
associating a media component with each of the coins, wherein a characteristic of the media component is based on the property associated with each individual coin; and
creating a media arrangement using one or more of the media components.

2. The method of claim 1 wherein the property of the coin is the denomination of the coin.

3. The method of claim 1 wherein the media component comprises at least one of an audio component and a video component.

4. The method of claim 1 wherein the media component is a musical note and the first characteristic of the media component is a musical pitch.

5. The method of claim 1, further comprising detecting a coin-sensing time difference for each individual coin, wherein the coin-sensing time difference is an amount of time between the receipt of a first coin and a subsequent coin that immediately follows the first coin, and wherein a second characteristic of the media component is based on the coin-sensing time difference of the associated coin.

6. The method of claim 5 wherein the second characteristic determines a time difference between the media components in the media arrangement.

7. The method of claim 1 wherein the media arrangement includes an audio arrangement.

8. The method of claim 1 wherein the media arrangement includes a video arrangement.

9. The method of claim 1 wherein creating the media arrangement is performed in response to a coin-sensing event, and the coin-sensing event occurs when a sequence of coins meets a predetermined condition.

10. The method of claim 9 wherein the predetermined condition is at least one of an accumulated value of the sequence, a count of the coins in the sequence, and a particular order of coins in the sequence.

11. The method of claim 1 wherein the one or more media components of the media arrangement are arranged in the same order that the coin counting machine received the coins associated with the one or more media components.

12. A method of operating a coin counting machine, the method comprising:
receiving a plurality of coins from a user;
creating a media arrangement based on the plurality of coins, wherein the media arrangement includes at least one of audio and video media; and
distributing the media arrangement.

13. The method of claim 12, further comprising:
detecting an individual property for each individual coin;
associating a media component with each of the coins, wherein the media arrangement includes one or more of the media components; and
outputting the media arrangement.

14. The method of claim 12 wherein distributing the media arrangement comprises sending the media arrangement to a cell phone.

15. The method of claim 12 wherein distributing the media arrangement comprises uploading the media arrangement to a website.

16. A non-transitory computer readable medium for controlling a coin counting machine, the computer readable medium containing instructions for causing the coin counting machine to perform a method comprising:
receiving a plurality of coins from a consumer;
detecting a property for each of the coins;
associating a media component with each of the coins, wherein the media components are based on the properties of the corresponding coins; and
creating a media arrangement using at least one of the media components.

17. The computer readable medium of claim 16 further comprising:
generating a presentation of the media arrangement.

18. The method of claim 16 wherein the media arrangement includes a song.

19. A consumer coin counting kiosk, comprising:
a coin receiving region for receiving a plurality of coins from a consumer;
means for detecting a property of each of the coins and associating a characteristic of a media component based on the property of each of the coins; and
means for creating a media arrangement using at least one of the media components.

20. The kiosk of claim 19 further comprising means for presenting the media arrangement.

21. The method of claim 2 wherein associating the media component with each of the coins comprises mapping the denomination of each of the coins to a corresponding musical note.

22. The method of claim 21 wherein the mapping comprises quantizing the music note to a closest beat on a musical scale.
